(19) United States
(12) Patent Application Publication
(10) Pub. No.: US 2008/0315555 A1
(43) Pub. Date: Dec. 25, 2008

(54) SLIDER SUSPENSION LOCKING PIN SYSTEM WITH LEAF SPRING

(76) Inventor: Steven G. Saieg, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/766,207

(22) Filed: Jun. 21, 2007

(51) Int. Cl. B62D 53/06

(52) U.S. Cl. 280/405.1; 280/149.2

(57) ABSTRACT

A trailer slider system includes a body rail that slides longitudinally relative to a suspension frame side rail. The body rail includes holes that provide multiple suspension positions. The trailer slider system also includes a pin locking system having at least one pin that is extendable into the holes in a locked position and retractable out of the holes in an unlocked position. A leaf spring biases the at least one pin toward one of the locked position or the unlocked position.

### BACKGROUND OF THE INVENTION

This disclosure generally relates to a locking mechanism for a slider suspension. Slider suspensions are used to reposition a suspension frame relative to a trailer body to redistribute axle loads as needed. Conventional slider suspensions include a locking system that locks the slider suspension in a desired position relative to the trailer body. The locking system includes a series of pins that are received in openings formed within the trailer body to lock the suspension frame to the trailer body. To adjust the position of the slider suspension, the pins are unlocked from the trailer body and a vehicle then moves the trailer body into a desired position relative to the slider suspension and suspension frame. The pins are then again locked to the trailer body.

One disadvantage with current systems is that pins may become stuck in an extended position, which significantly increases the effort required to make an adjustment. Or, the vehicle could be driven without the pins being fully engaged to the trailer body. This could cause the slider suspension to collide with the trailer body resulting in damage to suspension components and the trailer body.

Another challenge with the use of a slider suspension is to ensure that the locking pins are engaged in the holes before the vehicle moves. If the locking pins are not fully engaged, then it is possible for the slider suspension to move relative to the trailer body, such as under hard braking or high acceleration. For example, if hard braking occurs when the pins are not fully engaged, the pins may jump past the holes as the trailer body moves forward relative to the slider suspension and suspension frame, causing the slider suspension to collide with the trailer body and resulting in damage to suspension components.

Thus, it would be beneficial to have a locking system with independent pin actuation to ensure that the locking pins properly engage and disengage, and a pin design that avoids jumping past the holes.

### SUMMARY OF THE INVENTION

An example trailer slider system includes a body rail that slides longitudinally relative to a suspension frame side rail. The body rail includes holes that provide multiple suspension positions. The trailer slider system also includes a pin locking system having at least one pin that is extendable into the holes in a locked position and retractable out of the holes in an unlocked position. A leaf spring biases a corresponding one of the at least one pins toward either the locked position or the unlocked position. For example, the leaf spring includes a fixed end and a free end that deflects relative to the fixed end to provide a spring force.

Another example trailer slider system is similar to the above, but includes a spring that biases a corresponding one of the pins toward the locked position when the pin locking system is in a first state and toward the unlocked position when the pin locking system is in a second state. For example, the states correspond to actuation of the pin suspension system to lock or unlock the pins.

Another example pin locking system includes a plurality of pins and a plurality of leaf springs biasing corresponding ones of the pins toward the locked position. A lever for moving the pins between the locked position and the unlocked position is coupled with a cam. The cam is coupled with respective ends of a first connection link and a second connection link. The other ends of the first and second connection links cooperate with respective ones of the pins such that the lever functions to selectively move the pins between the locked and unlocked positions.

These and other features of the present invention can be best understood from the following specification and drawings, the following of which is a brief description.

### BRIEF DESCRIPTION OF THE DRAWINGS

FIG. 1 is a bottom perspective view of a suspension slider incorporating one example configuration of a locking mechanism.

FIG. 2 is a top perspective view of the suspension slider of FIG. 1.

FIG. 3 is a view of the locking mechanism of FIG. 1.

FIG. 4 is a view of a first example pin for use in the locking mechanism of FIG. 1.

FIG. 5 is a view of a second example pin for use in the locking mechanism of FIG. 1.

FIG. 6 is a view of a third example pin for use in the locking mechanism of FIG. 1.

FIG. 7 is a view of an example connection between a pin and a leaf spring.

FIG. 8 is a view of an example connection between a connection link and a leaf spring.

FIG. 9 is a view of another example connection between a connection link and a leaf spring.

FIG. 10 is a view of a leaf spring biasing a pin into a locked position.

FIG. 11 is a view of a leaf spring biasing a pin into an unlocked position.

FIG. 12 is a view of a leaf spring biasing a pin toward an unlocked position.

### DETAILED DESCRIPTION OF THE PREFERRED EMBODIMENT

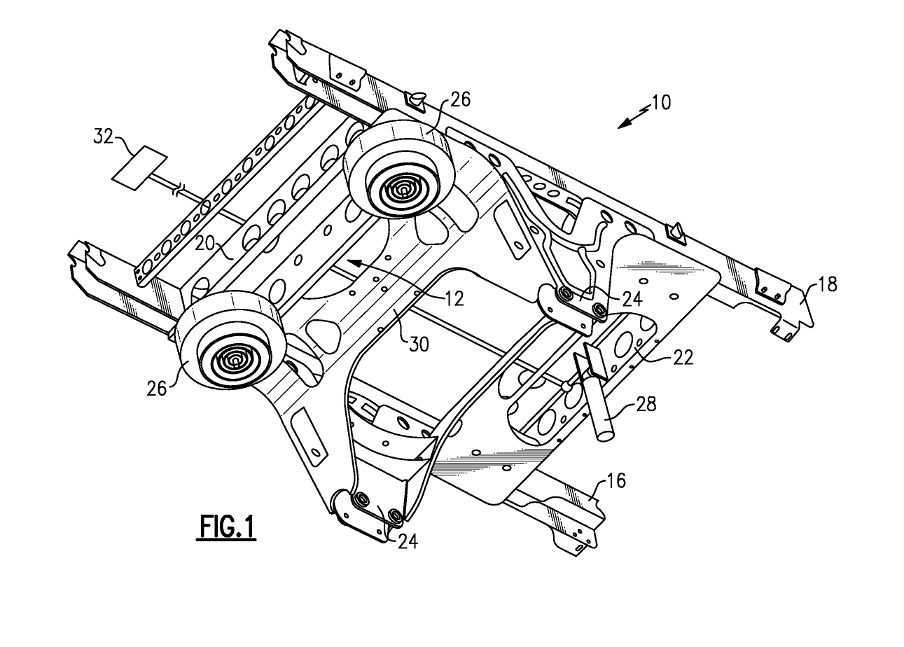

FIG. 1 is a bottom perspective view of an example trailer slider system 10 incorporating one example configuration of a locking mechanism 12. The trailer slider system 10 is used to reposition wheels relative to a trailer support structure, such as a suspension frame, associated with a trailer that is pulled by a vehicle (not shown) to redistribute axle loads as needed. The trailer slider system 10 includes the locking mechanism 12 that locks the trailer slider system 10 in a desired position relative to the trailer support structure. Trailer support structures are well known and any type of trailer support structure can be used with the trailer slider system 10.

In the example shown in FIGS. 1-2, the trailer slider system 10 includes first 16 and second 18 longitudinal members that are laterally spaced apart from each other, and first 20 and second 22 cross-members that extend between the first 16 and second 18 longitudinal members. The first 20 and second 22 cross-members are longitudinally spaced apart from each other.

Hanger brackets 24 extend from the first 16 and second 18 longitudinal members to support suspension components (not shown) as known. The suspension components are associated with axles (not shown) also as known, with spring elements 26 (FIG. 1) being positioned between the trailer slider system 10 and the axles. A single shock absorber 28 is positioned between each axle and a respective one of the first 20 and second 22 cross-members. A belly pan 30 (best seen in FIG. 1) is connected to the first 16 and second 18 longitudinal members, the first 20 and second 22 cross-members, and to the hanger brackets 24 to provide increased structural rigidity for the trailer slider system 10.

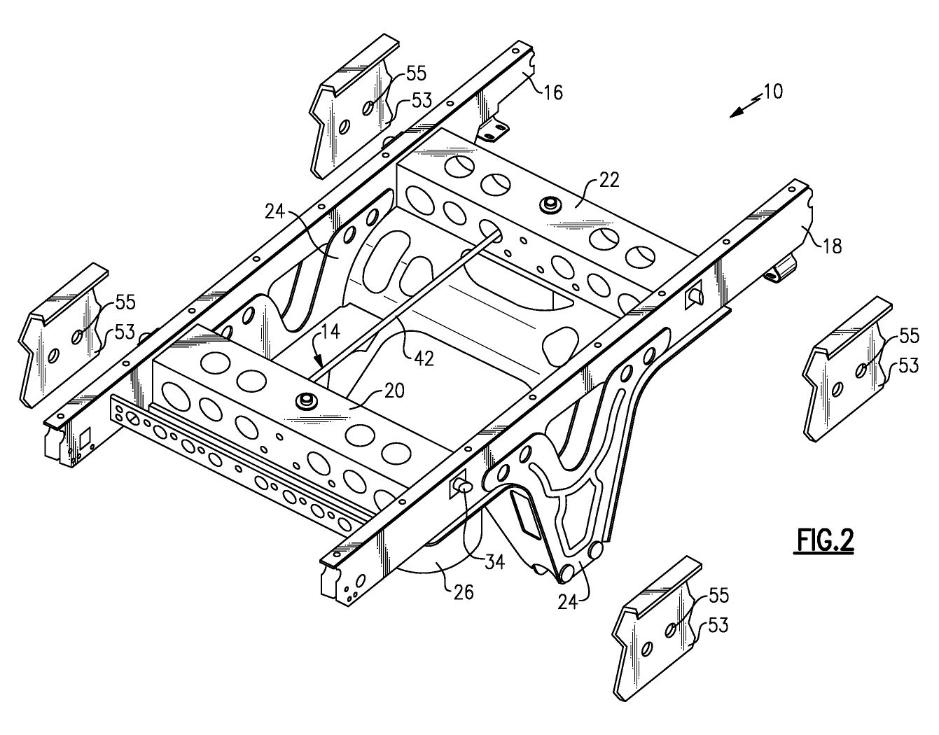

The locking mechanism 12 is actuated by an actuator 32 (shown schematically in FIG. 3) that moves the locking mechanism 12 between a locked or extended position where the trailer slider system 10 is locked to a trailer support structure, and an unlocked or retracted position where a vehicle can move the trailer support structure relative to the trailer slider system 10 to reposition axle loads as needed. The actuator 32 may be a pneumatic device, lever, manual pull handle, or other suitable device for moving the locking mechanism 12 between the locked and extended positions. For example, the actuator 32 is a handle that pivots about pivot P when pulled to unlock the locking mechanism 12.

An example of the locking mechanism 12 is shown in FIG. 3. The locking mechanism 12 includes a plurality of pins 34 that extend through the first 16 and second 18 longitudinal members to lock into the trailer support structure when moved into the locked position. In the example shown, the plurality of pins 34 includes a front set of laterally spaced pins 34a, 34b and a rear set of laterally spaced pins 34c, 34d. Pins 34a and 34c are associated with the first longitudinal member 16 and pins 34b, 34d are associated with the second longitudinal member 18.

Each pin 34a, 34b, 34c, 34d is associated with a pin connection link 36. Each pin connection link 36 is connected on its opposite end with one link member 33, 35. The front link member 33 actuates the rear link member 35 via a fore-aft link 42 that extends longitudinally relative to the trailer slider system 10. The fore-aft link 42 acts in tension and thus can comprise a cable, or a rigid rod or tube. In the example shown, the actuator 32 is coupled with the front link member 33 such that moving the link member 33 moves the link member 35 and each pin connection links 36. Alternatively, cams may be used in place of the link members 33 and 35.

As shown, each of the plurality of pins 34 is configured with a tip 44 that extends through a corresponding hole 55 (FIG. 2) of a body rail 53 (shown in partial in FIG. 2) to provide better pin engagement in the locked position.

FIGS. 4-6 illustrate a few different examples of the pins 34. In the embodiment shown in FIG. 4, the pin 34 includes a periphery, which in one example is a cylindrical surface, having a long side 64 and a short side 66. In this example, the periphery is spaced axially from the apex 62. A ramped surface 60 extends from the apex 62, which lies along the long side 64, to the short side 66 opposite the long side 64. In the example shown, the ramped surface 60 is a generally planar surface and the apex 62 is offset from a centerline axis A of the pin 34. The ramped surface 60 enables the pin 34 to extend through the hole 55 in the body rail 53 prior to the centerline axis A of the pin 34 and a centerline of the hole 55 being substantially aligned. Thus, the body rail 53 is prevented from moving relative to the longitudinal members 16, 18 when the pins 34 are misaligned with the holes 55.

In the embodiment shown in FIG. 5, a ramped surface 60′ of a tip 44′ of the pin 34 is truncated to create an apex face 86. The area of the apex face 86 is controlled by the amount of the ramped surface truncation and the angle of the ramped surface 60′. As described above, the ramped surface 60′ enables the pin 34 to extend through the hole 55 in the body rail 53 prior to the centerline axis A of the pin 34 and a centerline of the hole 55 being substantially aligned.

In the embodiment shown in FIG. 6, a tip 44″ provides a stepped profile having a reduced area extension portion 330 extending outwardly from one edge 316 of the pin 34. The extension portion 330 enables the pin 34 to extend through the hole 55 in the body rail 53 prior to the centerline axis A of the pin 34 and a centerline of the hole 55 being substantially aligned, as described above.

Additional non-limiting examples of pins and tips are set forth in application Ser. No. 11/248,038 filed on Oct. 12, 2005, which is owned by the assignee of the present invention.

Each of the pins 34a-d is coupled with a corresponding leaf spring 68 (FIG. 3). The leaf springs 68 each include a fixed end 69 and a free end 70 that deflects relative to the fixed end 69. The fixed end 69 is secured to one of the longitudinal members 16, 18. Alternatively, the fixed end 69 may be secured to another suitable support. In the illustrated example, the leaf spring 68 includes a single layer of spring steel. Optionally, as represented by the dashed lines 68a, the leaf springs 68 may include multiple layers of spring steel or other material to provide a desired amount of spring force.

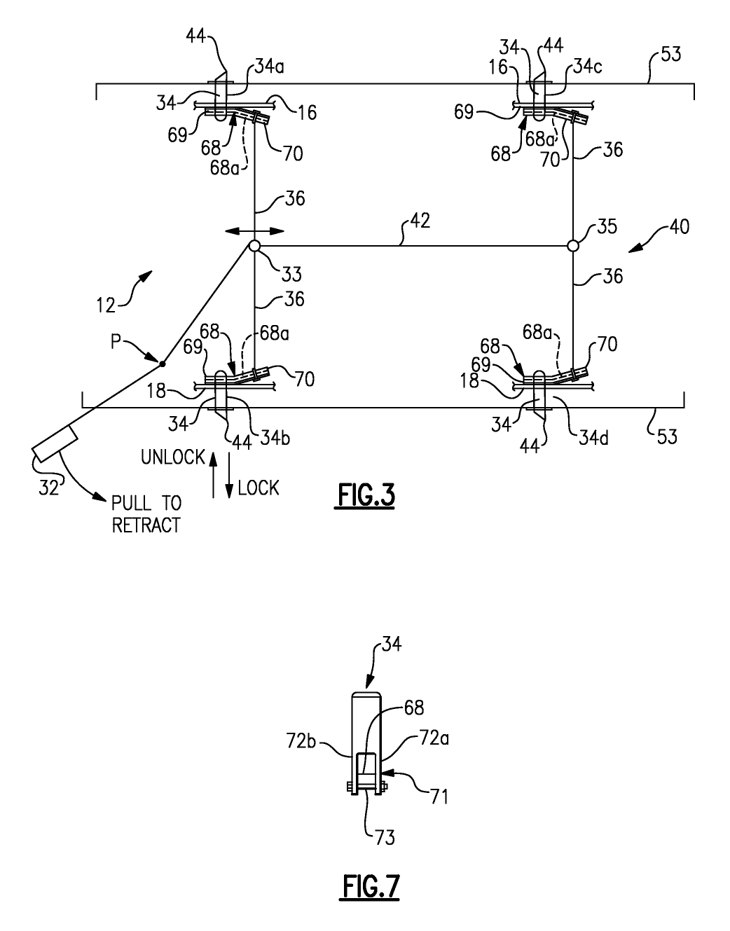

Referring to FIG. 7, each pin 34 includes a U-shaped end 71 having spaced-apart side walls 72a and 72b. A locking pin 73 extends between the side walls 72a and 72b. The leaf spring 68 is received through the U-shaped end 71 and the locking pin 73 secures the leaf spring 68 between the spaced-apart side walls 72a and 72b. The leaf spring 68 is not constrained from laterally sliding through the U-shaped end 71, but is constrained in the axial direction of the pin 34 by the bottom of the U-shaped end 71 and the locking pin 73.

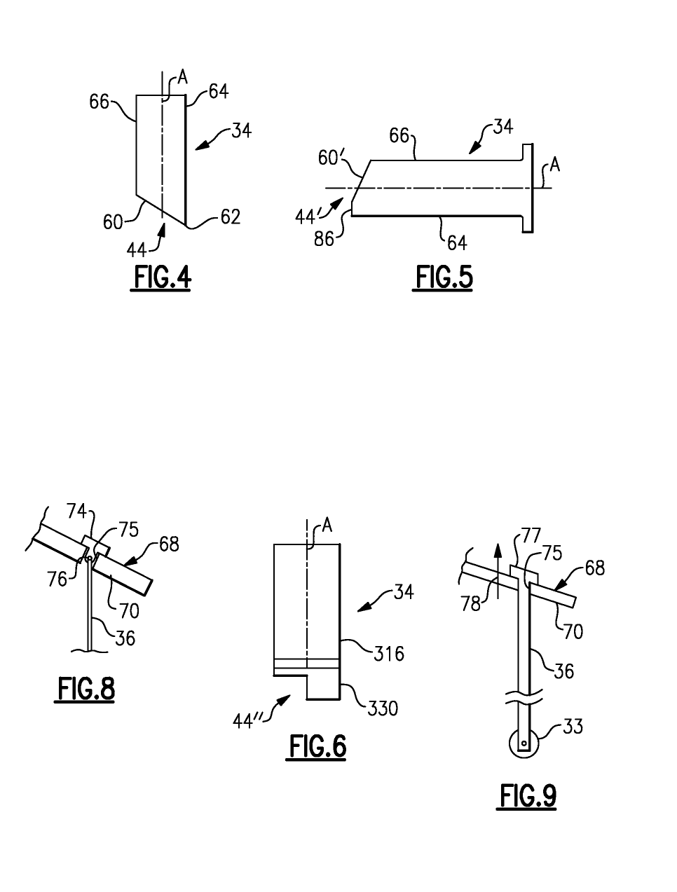

Referring to FIG. 8, the connection links 36 are pivotally coupled to the free end 70 of the leaf springs 68. In the illustrated example, a connector 74 extends through an opening 75 in the leaf spring 68 and connects to the connection link 36 at a pivot 76. The connection link 36 may be a relatively rigid shaft, cable, or other suitable connection. Given this description, one of ordinary skill in the art will recognize other type of connections to meet their particular needs.

FIG. 9 illustrates another embodiment wherein the connection link 36 is a rigid shaft that includes a stop 77. The stop 77 is larger than a thickness of the rigid shaft such that the stop 77 resists sliding movement of the leaf spring 68 in a direction 78 toward the stop 77 and permits the leaf spring 68 to slide axially along the rigid shaft toward the cam 33. The stop 77 thereby provides the benefit of allowing the connection link 36 to act on the leaf spring 68 in only one direction (i.e., by deflecting the leaf spring 68 toward the cam 33).

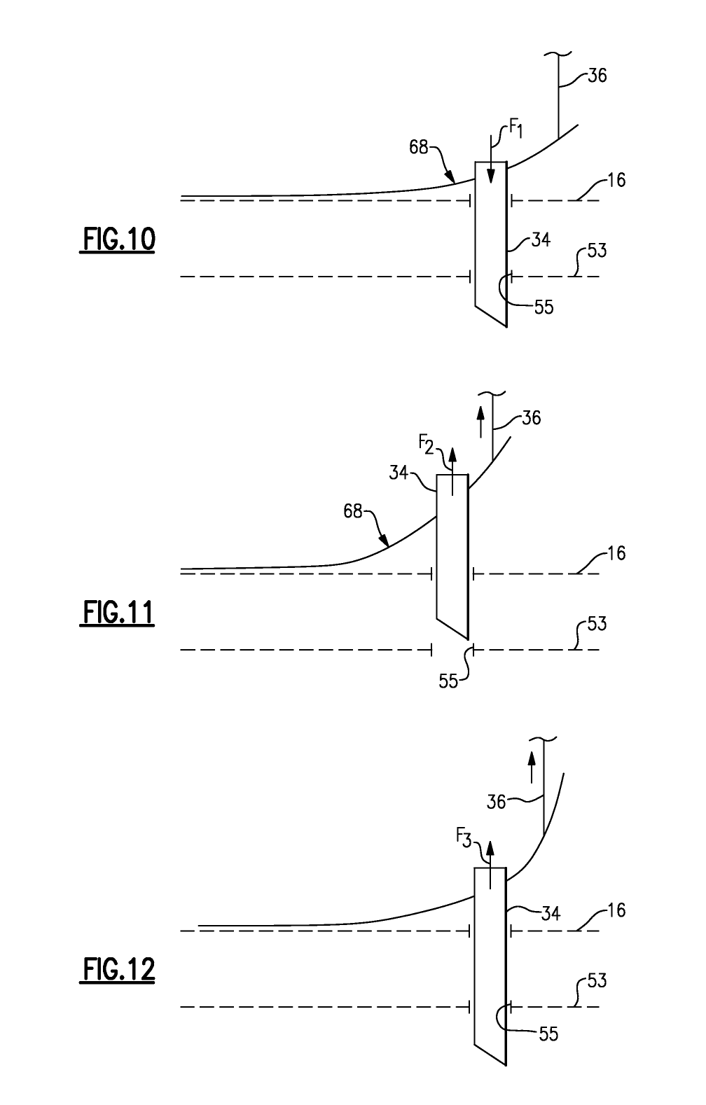

Referring to FIG. 10, the leaf springs 68 bias the respective pins 34 toward one of the locked position or the unlocked position, depending upon a state of the trailer slider system 10. Although the disclosed example illustrates using leaf springs 68, it is to be understood that other types of springs may alternatively be used to achieve the functionality provided by the leaf springs 68. Given this description, one of ordinary skill in the art will be able to recognize such springs and arrangements.

The leaf springs 68 bias the respective pins 34 toward the locked position (i.e., engaged with the opening 55) when the trailer slider system 10 is in a released state. That is, the actuator 32 has not been actuated to move the connection links 36 and the pins 34. The leaf springs 68 bias the respective pins 34 with a bias force F₁ toward the openings 55. Biasing the pins 34 towards the openings 55 provides the benefit of having each pin 34 independently biased toward a default locked position to prevent relative movement between the body rail 53 and suspension frame.

Referring to FIG. 11, upon actuation of the actuator 32 to move the connection links 36, the connection links 36 deflect the respective leaf springs 68 to provide a retraction force F₂ on the pins 34. Under normal conditions (e.g., the pins 34 do not stick within the openings 55), the retraction force F₂ biases the pins 34 toward the unlocked position to retract the pins 34 from the openings 55.

Referring to FIG. 12, one or more of the pins 34 may occasionally stick in the locked position and resist retraction to the unlocked position upon actuation of the actuator 32. Under this condition, the connection links 36 deflect the respective leaf springs 68 to provide a retraction force F₃ on the pins 34. The retraction force F₃ biases the stuck pin 34 toward the unlocked position. As the connection link 36 deflects the leaf spring 68, an increasing amount of spring force of the leaf spring 68 increases the retraction force F₃ to overcome the sticking of the pin 34. The leaf springs 68 thereby provide the benefit of independently dislodging stuck pins 34. It is to be understood that the forces F₁, F₂, and F₃ may each represent a resultant force of different component forces that the connection links 36 apply to the respective pins 34.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A trailer slider system including a body rail that slides longitudinally relative to a suspension frame side rail, the body rail including holes that provide multiple suspension positions, the trailer slider system comprising:
a pin locking system having at least one pin that is extendable into the holes in a locked position and retractable out the holes in an unlocked position; and
a leaf spring biasing the at least one pin toward one of the locked position or the unlocked position.

2. The trailer slider system according to claim 1, wherein the leaf spring biases the at least one pin toward the locked position when the pin locking system is in a first state and toward the unlocked position when the pin locking system is in a second state that is different from the first state.

3. The trailer slider system according to claim 1, further comprising a connection link coupled with the leaf spring that selectively actuates to deflect the leaf spring and provide a retraction force on the at least one pin.

4. The trailer slider system according to claim 3, wherein the leaf spring biases the at least one pin toward the unlocked position in response to the actuation of the connection link to unlock the at least one pin and toward the locked position in response to actuation of the connection link to lock the at least one pin.

5. The trailer slider system according to claim 3, wherein the connection link comprises a cable.

6. The trailer slider system according to claim 3, wherein the connection link comprises a rigid shaft.

7. The trailer slider system according to claim 6, wherein the leaf spring includes an opening, and the rigid shaft is slidably received through the opening.

8. The trailer slider system according to claim 7, wherein the rigid shaft includes a stop that resists sliding movement of the leaf spring along the rigid shaft in a direction toward the stop.

9. The trailer slider system according to claim 1, wherein the leaf spring includes a fixed end and a free end that is coupled with the at least one pin.

10. The trailer slider system according to claim 1, wherein the leaf spring includes multiple layers of spring steel.

11. The trailer slider system according to claim 1, wherein the at least one pin includes a U-shaped end having spaced-apart side walls, and a locking pin that extends between the spaced-apart side walls to secure the leaf spring within the U-shaped end.

12. The trailer slider system according to claim 1, wherein the leaf spring biases the at least one pin toward the locked position.

13. A trailer slider system comprising:
a body rail that slides longitudinally relative to a suspension frame side rail, the body rail including holes that provide multiple suspension positions, the trailer slider system comprising:
a pin locking system having a plurality of pins that are each extendable into corresponding ones of the holes in a locked position and retractable out of one of the holes in an unlocked position;
a plurality of leaf springs biasing corresponding ones of the plurality of pins toward the locked position;
a first connection link having one end with a first pin of the plurality of pins;
a second connection link having one end cooperating with a second pin of the plurality of pins; and
a lever coupled with the first connection link and the second connection link for moving the plurality of pins between the locked position and the unlocked position.

14. The trailer slider system according to claim 13, wherein movement of the lever causes deflection of the plurality of leaf springs to provide a retraction force on the plurality of pins.

15. The trailer slider system according to claim 13, wherein the plurality of leaf springs bias the corresponding ones of the plurality of pins toward the locked position in response to actuation of the lever to lock the plurality of pins and toward the unlocked position in response to actuation of the lever to unlock the plurality of pins.

16. The trailer slider system according to claim 13, further comprising a link member coupled with the lever, the first connection link, and the second connection link.

17. The trailer slider system according to claim 16, further comprising a third connection link having one end coupled to the link member and an opposite end coupled with a second link member.

18. The trailer slider system according to claim 17, further comprising a fourth connection link having one end coupled to the second link member and an opposite end cooperating with a third pin of the plurality of pins.

19. The trailer slider system according to claim 18, further comprising a fifth connection link having one end coupled to the second link member and an opposite end cooperating with a fourth pin of the plurality of pins.

20. A trailer slider system including a body rail that slides longitudinally relative to a suspension frame side rail, the body rail including holes that provide multiple suspension positions, the trailer slider system comprising:
a pin locking system having at least one pin that is extendable the holes in a locked position and retractable out of the holes in an unlocked position; and
a spring that biases the at least one pin toward the locked position when the pin locking system is in a first state and toward the unlocked position when the pin locking system is in a second state that is different from the first state.

21. The trailer slider system according to claim 20, wherein the first state corresponds to an actuation of the pin locking system to lock the at least one pin and the second state corresponds to an actuation of the pin locking system to unlock the at least one pin.
